(19) United States
(12) Patent Application Publication
(10) Pub. No.: US 2016/0294665 A1
(43) Pub. Date: Oct. 6, 2016

(54) SELECTIVELY DEPLOYING PROBES AT DIFFERENT RESOURCE LEVELS

(71) Applicant: Martin Carl FOWLER, Fort Collins, CO (US)

(72) Inventor: Martin Carl FOWLER, Fort Collins, CO (US)

(73) Assignee: CA, INC., New York, NY (US)

(21) Appl. No.: 14/934,944

(22) Filed: Nov. 6, 2015

Related U.S. Application Data
(63) Continuation-in-part of application No. 14/832,223, filed on Aug. 21, 2015.
Application No. 14/832,223 is a continuation-in-part of application No. 14/673,070, filed on Mar. 30, 2015.

(51) Int. Cl. H04L 12/26

(52) U.S. Cl. CPC H04L 43/12; H04L 43/16

(57) ABSTRACT

Systems and methods may include deploying a first probe within a unified infrastructure management (UIM) system to monitor a system-level resource. The systems and methods may include determining that a monitored value for the system-level resource has crossed a threshold value. The systems and methods may include deploying a second probe within the UIM system to monitor a process-level resource in response to determining that the monitored value for the system-level resource has crossed the threshold value. The systems and methods may include storing information about the process-level resource obtained by the second probe in a memory.

### CROSS-REFERENCE TO RELATED APPLICATION

This application is a continuation-in-part of U.S. patent application Ser. No. 14/832,223, filed Aug. 21, 2015, which is a continuation-in-part of U.S. patent application Ser. No. 14/673,070, filed Mar. 30, 2015, the disclosures of which are incorporated herein by reference.

### BACKGROUND

The present disclosure relates to monitoring and data collection and, more specifically, to systems and methods for selectively deploying probes at different resource levels.

A probe is a program that may be installed on a robot for the purpose of monitoring or collecting data about network activity, system and application performance, and availability.

A robot is a program that may run on a system and control probe operation, manage probe communication, and pass data and alarms from probes to a hub.

The hub may be the backbone of a unified infrastructure management (UIM) system, which may bind together robots and hubs into a logical structure. The structure may be based on physical network layout, location or organizational structure, but there are generally no restrictions in how the infrastructure is organized. In addition to managing the infrastructure, the hub may also be responsible for: message distribution, name services, tunnel services, security, authentication and authorization. In addition, a hub may include one or more queues therein.

A queue is a holding area for messages passing through a hub. The queues may be temporary or they may be defined as permanent queues. The permanent queues will survive a hub restart and is meant for service probes that need to pick up all messages regardless of whether the service probe is running or not. The temporary queue, on the other hand, is cleared during restarts.

### BRIEF SUMMARY

According to an aspect of the present disclosure, a method may include several processes. In particular, the method may include deploying a first probe within a unified infrastructure management (“UIM”) system to monitor a system-level resource. In addition, the method may include determining that a monitored value for the system-level resource has crossed a threshold value. The method also may include deploying a second probe within the UIM system to monitor a process-level resource in response to determining that the monitored value for the system-level resource has crossed the threshold value. Moreover, the method may include storing information about the process-level resource obtained by the second probe in a memory.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 is a schematic representation of a network including a plurality of devices, hubs, probes, and other components.

FIG. 2 is a schematic representation of a system configured to implement processes of hub filtering.

FIG. 3 illustrates a process of selectively deploying probes at different resource levels.

FIG. 4 illustrates a process of deploying a second probe.

FIG. 5 illustrates a process of un-deploying the second probe deployed in accordance with FIG. 4.

FIG. 6 illustrates an example of a table showing data about a plurality of process-level resources in a dashboard-based interface.

FIG. 7 illustrates an example of another table showing data about a plurality of process-level resources in a dashboard-based interface.

FIG. 8 illustrates an example of a table showing data about a plurality of system-level resources in a dashboard-based interface.

FIG. 9 illustrates an example of another table showing data about a plurality of system-level resources in a dashboard-based interface.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to information technology, systems and methods disclosed herein may be related to any field that may be associated with monitoring communication between devices and/or monitoring the status of devices. Systems and methods disclosed herein may be applicable to a broad range of applications that perform a broad range of processes.

When anomalous events occur in a telecommunication network, network components may become damaged or begin malfunctioning. Consequently, other network components may be unable to communicate with the damaged or malfunctioning components or may receive errant communications a flood of data packets from a hacked component, garbled messages from a damaged component, automated alerts from damaged components). For example, as a result of damage to a component, normally-functioning network components may be unable to forward data packets addressed to such damaged component and may be required to queue such data packets until the anomaly has been resolved. As another example, a normally-functioning network component may receive a flood of data packets from a network component that has been hacked or infected by a virus. This may lead to the memory associated with such network components reaching near its maximum capacity and/or increased utilization of a processing component associated with such components, for example.

When anomalous events occur in a telecommunications network where hubs are located, or when anomalous events occur on a system where a hub is installed, the hub-to-hub message flow may become blocked, and queues may accumulate messages, pushing the memory spaces dedicated to such hubs to capacity, for example. The blocked messages may contain time-critical metric and alarm data that may convey the status of monitored systems, applications, and networks and may ultimately be lost when memory capacity reaches a maximum. Thus, it may be important to quickly identify hubs with blocked messages and take appropriate remedial measures to ensure the adequate performance of monitored systems, applications, and networks, for example.

Similarly, when the utilization of a system level resource becomes anomalous e.g., the utilization approaches the resource's maximum or minimum capacity, the utilization changes in an extreme manner, the utilization unexpectedly changes, the utilization changes according to some pattern), such anomalous behavior may indicate that a problem exists within the system. In order to diagnose and resolve the problem, it may be necessary to monitor the system in more detail. Specifically, the utilization of a system level resource may have become anomalous as a result of a rouge or otherwise anomalous process, and it may be advantageous to monitor process-level resources to determine whether such a process is causing the anomaly and to identify such process. Consequently, systems and methods disclosed herein may address this (problem by deploying and/or repurposing additional probes to monitor process level resources in response to the detection of an anomaly in a system level resource. Although certain examples of the systems and methods contemplated by this disclosure may be described in relation to memory utilization and message queues, such systems and methods may readily monitor a plurality of different resources, such as CPU utilization, up-time, temperature, energy consumption, and cooling system utilization, for example.

Certain systems and methods disclosed herein may allow for visualization of hub status and performance for all hubs in a deployment in one dashboard, for example. Information on a hub-by-hub basis may be available within native interfaces through each hub, however, it may be difficult to obtain a holistic view of the status and performance of a particular group of hubs. For example, in a 200 hub deployment, the administrator would need to view the interface for every single hub, which is not an efficient (or even feasible) solution given the demands placed on a network administrator and the need to understand the network in a comprehensive manner at all times. The lack of a holistic solution is a challenge for network administrators, as problems with remote hubs may interrupt the flow of time-critical data to the central server.

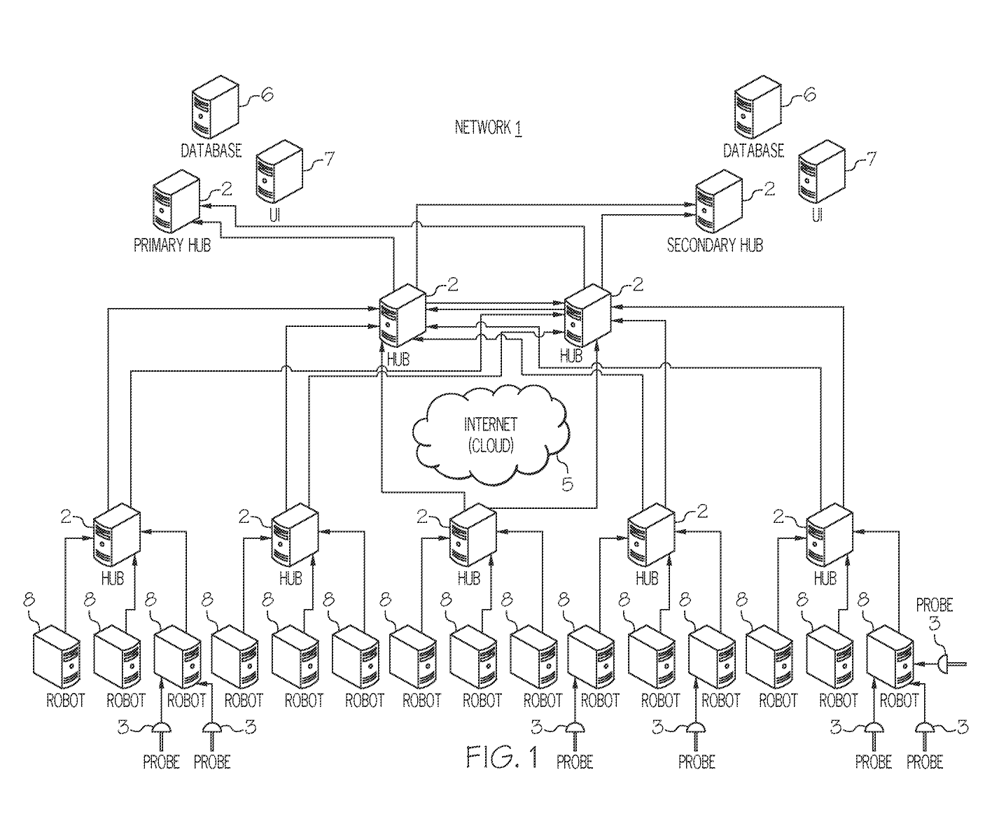

Referring now to FIG. 1, a network 1 including a plurality of hubs 2, probes 3, databases 6, user interfaces 7, robots 8, and other components now is described. Network 1 may connect with and/or include clouds 5 and/or a plurality of network devices (not shown). Clouds 5 may be public clouds, private clouds, or community clouds, for example. Also, network 1 may include one or more of a LAN, a WAN, or another type of network. Moreover, network 1 may include and/or be connected to the Internet. Components within network 1 may be connected wirelessly in addition to or in lieu of wired connections, for example.

Each cloud 5 may permit the exchange of information and services among users that are connected to such clouds 5. In certain configurations, cloud 5 may be a wide area network, such as the Internet. In some configurations, cloud 5 may be a local area network, such as an intranet. Further, cloud 5 may be a closed, private network in certain configurations, and cloud 5 may be an open network in other configurations. Cloud 5 may facilitate wired or wireless communications of information among users that are connected to cloud 5.

Network 1 may include a plurality of network devices, which may be, for example, one or more of general purpose computing devices, specialized computing devices, mobile devices, wired devices, wireless devices, passive devices, routers, switches, mainframe devices, monitoring devices, infrastructure devices, desktop computers, laptop computers, tablets, phones, wearable accessories, and other devices. Such network devices may communicate by transmitting data packets that include one or more messages, which are processed by a UIM system.

As noted above, network 1 may include a plurality of hubs 2. Hubs 2 may be virtual devices implemented through software running on dedicated hardware, for example. In particular, hubs 2 may function as connection points between components associated with network 1. Each hub 2 may receive data packets (e.g., UIM messages) from one or more robots 8 and/or one or more other hubs 2 and forward such data packets to one or more other robots 8 and/or one or more other hubs 2. Hubs 2 may be established by service functions, for example.

In certain configurations, a hub 2 may queue received messages in one or more queues within such hub 2 prior to sending. For example, hub 2 may have different queues for different types of messages, for messages received from different components or different hubs 2, and/or for messages to be sent to different components or hubs 2. Each queue may utilize a portion of memory dedicated to the hub 2 associated with such queue.

Network 1 may further include a plurality of probes 3. In some configurations, probes 3 may be selectively deployed throughout network 1 as needed (e.g., when desired, when an anomaly occurs, when it is predicted that an anomaly will likely occur, when a particular event occurs). In other configurations, probes 3 may be permanently deployed within network 1. Probes 3 may be virtual devices implemented through software, for example. Probes 3 may be installed on a particular robot 8, for example. Probes 3 may monitor data transmitted within network 1, may discover components within network 1 (e.g., hubs 2), and/or may interface with such components to access and retrieve data from such components (e.g., identifying information for such components, a total number of components in network 1, utilization of resources for such components at one or more resource levels, a total number of queues within a hub 2, identifying information for each queue within a hub 2, a total number of messages sent by a hub 2 since such hub 2 was most-recently activated, a total number of messages received by a hub 2 since such hub 2 was most-recently activated, a total number of messages queued in a hub 2, a total number of messages in a particular queue within a hub 2, uptime for such components).

Network 1 may include one or more database 6 that may store and aggregate information corresponding to hubs 2 that was acquired by probe 3. Network 1 also may include a user interface (UI) 7 that may generate a user interface, such as a dashboard, that permits an administrator to efficiently access the information stored in one or more databases 6. In addition, as described above, network 1 may include a plurality of robots 8, which may send UIM messages to hubs 2, and which may receive UIM messages from hubs 2. Robots 8 may manage, probe, and send probe messages to their corresponding hubs 2.

Particular systems and methods disclosed herein may utilize CA UIM hubs, which may be software programs that run on processing systems for the purpose of passing CA UIM messages to a central CA UIM server. In such systems and methods, the probe may similarly be a software program that runs on a robot. Such a probe may be installed in the domain, and all hubs within the domain may be discovered by the probe, regardless of where they reside. Likewise, the robot may also be a software program that manages probes, and sends probe messages to its hub. It may be possible to monitor multiple domains, with one monitoring probe in each domain. Such processing systems may be dedicated devices optimized to execute the hub, probe, and robot software programs, for example. System 100, which is described in more detail below, may be an example of one such processing system. As used herein, a processing system may refer to a single processor or a plurality of processors. In some configurations, each processor within a processing system may be configured to perform a dedicated function. In other configurations, one or more of the processors within a processing system may be configured to perform a plurality of functions, for example.

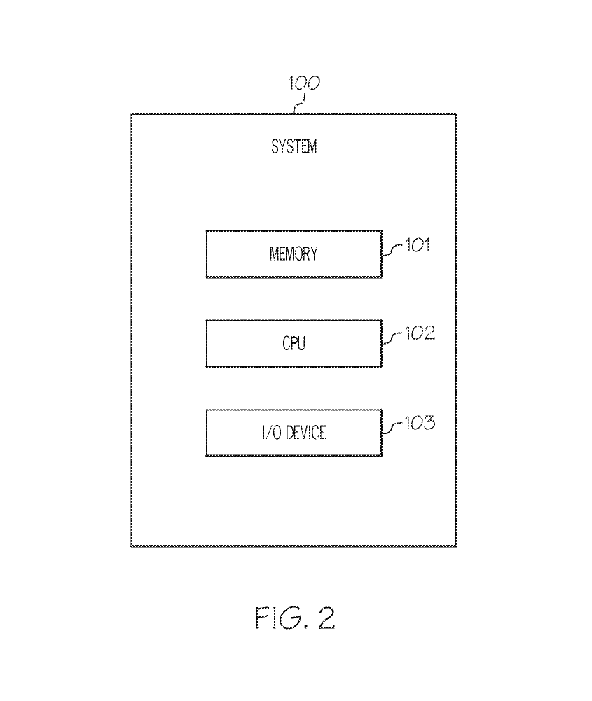

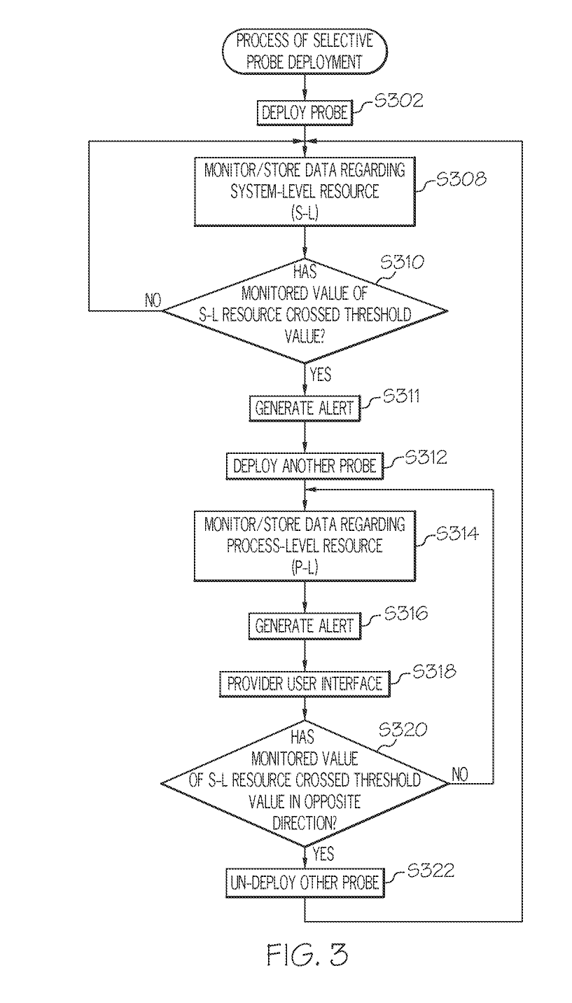

Referring to FIG. 2, system 100 is now described. System 100 may reside on one or more networks 1. System 100 may comprise a memory 101, a central processing unit (“CPU”) 102, and an input and output (“I/O”) device 103. Memory 101 may store computer-readable instructions that may instruct system 100 to perform certain processes. In particular, memory 101 may store computer-readable instructions for performing and/or controlling a process of selectively deploying probes at different resource levels. When such computer-readable instructions are executed by CPU 102, the computer-readable instructions stored in memory 101 may instruct CPU 102 to perform a plurality of functions. Examples of such functions are described below with respect to FIG. 3. System 100 may be used to implement one or more of hubs 2, probe 3, databases 6, UIs 7, and robots 8, as well as other components within network 1.

I/O device 103 may receive one or more of data from networks 1, data from other devices, probes, and sensors connected to system 100, and input from a user and provide such information to CPU 102. I/O device 103 may transmit data to networks 1, may transmit data to other devices connected to system 100, and may transmit information to a user (e.g., display the information, send an e-mail, make a sound). Further, I/O device 103 may implement one or more of wireless and wired communication between system 100 and other devices in network 1 and/or cloud 5.

Referring now to FIG. 3, a process of selectively deploying probes at different resource levels now is described.

In S302, system 100 may deploy at least one probe 3 within network 1. In certain implementations, system 100 may deploy such probe(s) 3 in response to a trigger event, for example, such as the occurrence of a specified condition or event, a monitored value nearing or reaching a threshold level, or information about anomalous activity within network 1. In other implementations, system 100 may deploy such probe(s) 3 on a periodic schedule, at predetermined intervals, or permanently when system 100 is activated.

One or more of the deployed probes 3 may monitor a system-level resource within network 1, such as disk usage, disk I/O, network utilization, CPU utilization for one or more components of network 1 (e.g., hubs 2, probes 3, robots 8, system 100), memory utilization for one or more components of network 1, and uptime or downtime for one or more components of network 1, for example. The probe 3 may monitor and track such system-level resources in aggregate, on a component-by-component basis, or in some combination thereof, for example. The systems where the monitoring is taking place (e.g., both at a system-level and at a process-level) may be robots and/or hubs that are also robots, for example.

Further, one or more of the deployed probes 3 may monitor a process-level resource within network 1, such as disk I/O, network usage, CPU utilization for processes running on one or more components of network 1 (e.g., hubs 2, probes 3, robots 8, system 100), memory utilization for processes running on one and or more components of network 1, for example. Such processes may include any process running on the system, for example. The probe 3 may monitor and track such process-level resources in aggregate, on a component-by-component basis, or in some combination thereof, for example.

System 100 may use the deployed probe(s) 3 to discover one or more hubs 2 within network 1. In certain implementations, the deployed probe(s) 3 may discover each active hub 2 within network 1 and determine the total number of active hubs 2 within network 1. For example, system 100 may control such probe(s) 3 to make various requests within network 1 and determine the presence of one or more hubs 2 when such hub(s) 2 respond(s) to such requests.

ISystem 100 may control one or more of the deployed probes 3 to access the interface of one or more of the discovered hubs 2. In particular, probe(s) 3 may interface with each hub 2 and begin communicating with such hubs 2. System 100 may control probe(s) 3 to retrieve data from the hub(s) 2 with which such probe(s) 3 have interfaced. In particular, a probe 3 may perform a callback operation to retrieve data from a hub 2. Such data may include, for example, one or more of identifying information for hub 2, a total number of queues within hub 2, identifying information for each queue within hub 2, a total number of messages sent by hub 2 in a given period of time, a total number of messages received by hub 2 in a given period of time, a total number of messages queued in hub 2, a total number of messages in each queue within hub 2, and resource utilization associated with the hub at a system level (as described below in more detail). Moreover, such data may include information about resources utilized by the hub 2.

In S308, system 100 may use one or more of the deployed probes 3 to monitor one or more system-level resources. More specifically, one or more of the deployed probes 3 may monitor a system-level resource within network 1, such as disk usage, disk I/O, network utilization, CPU utilization for one or more components of network 1 (e.g., hubs 2, probes 3, robots 8, system 100), memory utilization for one or more components of network 1, and uptime or downtime for one or more components of network 1, for example. The probe 3 may monitor and track such system-level resources in aggregate, on a component-by-component basis, or in some combination thereof, for example. System 100 may store data regarding values of the system-level resource in a memory and may establish a history of performance for the system-level resource.

In S310, system 100 may determine whether the monitored value of the system-level resource has crossed a threshold value. In some configurations, the threshold value may be a value of the system-level resource that indicates an anomaly or other unusual behavior is occurring or is likely to occur, For example, the threshold value may be 95% utilization of a processor or of a memory, which may suggest that a rouge process is over-utilizing the processor and/or causing memory over-utilization (e.g., storing too much data, failing to delete data, otherwise operating anomalously). Conversely, the threshold value may be a low utilization, such as 10% utilization, which may suggest that a process is not functioning, for example. More generally, the threshold value may be a value of the monitored parameter that indicates that further and/or more-detailed information (e.g., information at a process level) may be useful to diagnose and/or prevent anomalies. In some configurations, the threshold value may be predetermined, such as a value determined based on historical data. In such configurations, the threshold value may be static or may be dynamically updated, periodically or in real time, as data is collected. In some other configurations, the threshold value may be input by an administrator, a user, and/or an external system.

In certain implementations, system 100 may determine whether the monitored value of the system-level resource has crossed a threshold value based on each monitored value for the system-level resource (e.g., each data point), such that even one instance of a monitored value crossing the threshold value may trigger a positive determination (S310: YES) in S310. In some implementations, system 100 may determine whether the monitored value of the system-level resource has crossed a threshold value based on an average of the monitored values for the system-level resource collected over some defined period of time (e.g., a 1 minute interval, a 1 hour interval, a 1 day interval, a 1 month interval, the entirety of time for which data has been collected, the period since the monitored value last crossed the threshold value, the period of time since a resource was last repaired or activated). In still other implementations, system 100 may determine whether the monitored value of the system-level resource has crossed a threshold value based on a plurality of monitored values for the system-level resource crossing the threshold (e.g., at least two each data points have crossed the threshold value) over some determined period of time.

When system 100 determines that the monitored value of the system-level resource has crossed the threshold value (e.g., increased above the threshold level, decreased below the threshold level) (S310: YES), the process may proceed to S312. When system 100 determines that the monitored value of the system-level resource has not crossed the threshold value (e.g., remains below an upper threshold level, remains above a lower threshold level) (S310: NO), the process may return to 5308 and continue monitoring the system-level resource.

In some implementations, system 100 also may generate an alert (S311) indicating that the monitored value for the system-level resource has crossed the threshold value response to determining that the monitored value of the system-level resource has crossed the threshold value (S310: YES) before, after, or during S312. The alert may provide notice that the threshold has been crossed and may provide a link to information about one or more process-level resources obtained by the one or more additionally-deployed probes described below and/or a summary of such information.

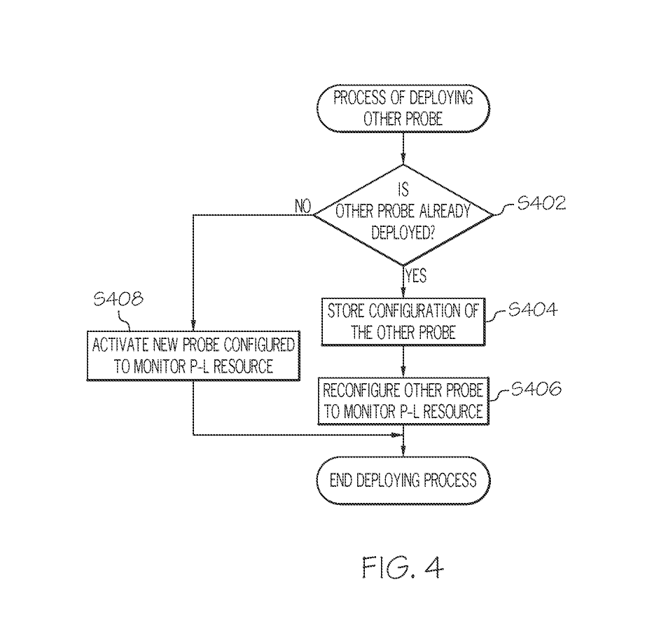

In S312, system 100 may deploy an additional one or more probes 3 within network 1 in response to determining that the monitored value for the system-level resource has crossed the threshold value. In certain implementations, system 100 may deploy one or more inactive or new probes 3 in S312. In some implementations, system 100 may deploy the additional one or more probes 3 in S312 by reconfiguring one or more already-deployed probes 3 (e.g., probes 3 that were monitoring process-level resources, probes 3 that were monitoring other resources and/or performing other functions). An example process of deploying the additional one or more probes 3 is described below in additional detail with respect to FIG. 4. The additional one or more probes 3 may be deployed from the same hub 2 as the probe 3 that monitors the system-level resource and/or may be deployed from one or more different hubs 2.

In S314, system 100 may use one or more of the additionally-deployed (e.g., newly-deployed, newly-activated, reconfigured) probes 3 to monitor one or more process-level resource within network 1, such as disk I/O, network utilization, CPU utilization for processes running on one or more components of network 1 (e.g., hubs 2, probes 3, robots 8, system 100), memory utilization for processes running on one and or more components of network 1, and uptime or downtime for one or more processes, for example. The probe 3 may monitor and track such process-level resources in aggregate, on a component-by-component basis, or in some combination thereof, for example. System 100 may store data regarding values of the process-level resource in a memory and may establish a history of performance for the process-level resource.

In S316, system 100 may analyze the data regarding values of the process-level resource to determine whether an anomaly has occurred or is likely to occur and to identify one or more processes that are associated with the anomaly. For example, system 100 may determine that an anomaly has occurred or is likely to occur, when the resource-utilization data for one or more process crosses a threshold value in a manner similar to that described above with respect to S310. The threshold may be greater than, less than, or the same as those associated with system-level resources. Upon determining that an anomaly has occurred or is likely to occur, system 100 may generate an alert indicating that the anomaly has occurred or is likely to occur and identifying the process or processes associated with the anomaly (e.g., the processes for which resource utilization has crossed the threshold value). Thereafter, system 100 may provide the alert to an administrator, a user, a technician, a management server, or another entity that monitors and/or maintains network 1. In certain implementations, the alert may be integrated into the user interface described below.

In S318, system 100 and/or another device connected with the memory storing the historical data associated with one or more system-level resource and the historical data associated with one or more process-level resource may access the historical data associated with one or more system-level resource and the historical data associated with one or more process-level resource. System 100 and/or the other device may use the accessed historical data to generate a user interface in which a user may access (e.g., view) information about the monitored system-level resources and the monitored process-level resources. In some implementations, the user interface may provide the user with the option to specify which system-level resources and/or which process-level resources are to be monitored and/or to specify threshold levels that may trigger the monitoring or system-level resources and/or process-level resources.

As an example, the user interface may present an aggregated list of system-level resources associated with a plurality of robots 8, for example. The user interface may provide an option to select a particular system-level resource from the aggregated list for further investigation. In response to receiving a selection of a particular system-level resource from the aggregated list, the user interface may provide additional information about the particular system-level resource, such as the various processes utilizing the system-level resource and the utilization of such resource by each process, for example.

The information provided by the user interface may be useful to determine whether a system (e.g., an SQL server database, a webserver application, a hub, another infrastructure system) is infected with a virus, has been hacked (e.g., is being used to implement a denial of service-type attack in which the system blasts other network components with an overwhelming number of outgoing messages), is under attack (e.g., by a denial of service-type attack that may be overwhelming the system with incoming messages), and/or is otherwise broken/malfunctioning, for example. In some implementations, a variety of characteristic information about the systems within the monitored environment may be determined and provided as part of the user interface, such as, for example, message rates for the system, system availability, system uptime, system memory utilization, system processor utilization, system throughput, and/or a plurality of other parameters.

The user interface may permit an administrator to view the network 1 and the system at a plurality of levels. For example, the user interface may present a network-level view of the network 1 that displays the total number of systems within the network 1, the total number of messages queued in the network 1, average incoming and outgoing message rates for the network 1, as well as other information, and/or the total memory and/or processor utilization within network 1. The network-level view also may include a list of the systems in the network 1, including corresponding identifiers for each system. This list also may include summary information about each system. When an administrator or other user selects one of the systems in the network-level view, the user interface may present a system-level view of the selected system that displays average incoming and outgoing message rates for the system, and/or the total memory and/or processor utilization within the system, as well as other information. Further, because process-level resources are monitored, the user interface may also identify the resource utilization (e.g., memory, processor) for each process running on network 1 by one or more components at various levels and may permit a user to drill-down by device level and/or resource level (e.g., system, hub, queue, process, function, component). Consequently, the user interface may permit the administrator to drill-down into the network 1 and learn about the network 1 at a plurality of levels.

The user interface may include a centralized dashboard that permits network administrators to easily access information about systems, processes, and other components and/or functions within a deployment and to drill down to obtain more specific information as needed. FIGS. 6-9 (described in more detail below) show example tables and charts that may be presented within the user interface. In some implementations, the user interface may include charts, diagrams, graphs, and/or other graphics.

In S320, system 100 may determine whether the monitored value of the system-level resource has crossed the threshold value in the opposite direction (e.g., returned to a value below an upper threshold, returned to a value above a lower threshold). Similar to the determination in S310, system 100 may determine whether the monitored value of the system-level resource has crossed the threshold value in the opposite direction based on each monitored value for the system-level resource (e.g., each data point) crossing the threshold in the opposite direction, based on an average of the monitored values for the system-level resource collected over some defined period of time crossing the threshold in the opposite direction and/or based on a plurality of monitored values for the system-level resource crossing the threshold in the opposite direction over some determined period of time, for example.

When system 100 determines that the monitored value of the system-level resource has crossed the threshold value in the opposite direction (e.g., returned to a value below an upper threshold, returned to a value above a lower threshold) (S320: YES), the process may proceed to S322. When system 100 determines that the monitored value of the system-level resource has not crossed the threshold value in the opposite direction (e.g., remains above an upper threshold level, remains below a lower threshold level) (S320: NO), the process may return to S314 and continue monitoring the process-level resource.

In some implementations, the determination in S320 may be based on the values of one or more monitored process-level resources returning to a value within a baseline range in addition to or in the alternative to the values of monitored system-level resources.

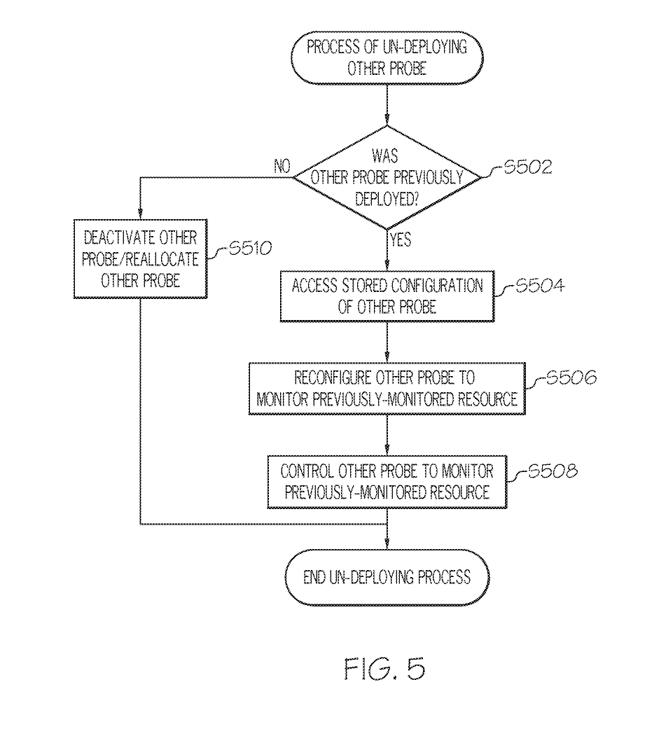

In S322, system 100 may un-deploy the additional one or more probes 3 within network 1 in response to determining that the monitored value for the system-level resource has crossed the threshold value in the opposite direction. In certain implementations, system 100 may deactivate one or more active probes 3 in S322. In some implementations, system 100 may un-deploy the additional one or more probes 3 in S312 by reconfiguring such probes 3 to another function (e.g., reconfiguring such probes 3 to perform a different function, reconfiguring such probes 3 to perform the function such probes 3 were performing prior (e.g., immediately prior, at some time before) to being reconfigured to monitor the process-level resource or resources). An example process of un-deploying the additional one or more probes 3 is described below in additional detail with respect to FIG. 5.

Referring now to FIG. 4, a process of deploying a second probe now is described.

In S402, system 100 may determine whether a probe 3 to be used for monitoring process-level resources has already been deployed. For example, a particular probe 3 may be designated as a process-level resource monitoring probe. In some configurations, the process-level resource monitoring probe may remain inactive and un-deployed unless such probe is monitoring process-level resources. In certain configurations, the process-level resource monitoring probe may be active and deployed to perform other functions (e.g., monitoring system-level resources, monitoring other resources, performing other probe functions) when not monitoring process-level resources. Moreover, different process-level resource monitoring probes may be designated to monitor different process-level resources and/or different processes.

When system 100 determines that a probe 3, which is to be used for monitoring process-level resources, has already been deployed (e.g., such probe 3 is active and deployed to perform other functions) (S402: YES), the process may proceed to S404. When system 100 determines that a probe 3, which is to be used for monitoring process-level resources, has not already been deployed (e.g., such probe 3 is inactive and not deployed to perform other functions) (S402: NO), the process may proceed to S408.

In S404, system 100 may obtain the current configuration (e.g., configuration parameters associated with the other function being performed, such as the type of function, the data being collected and/or transmitted, the resources being monitored) of the active and deployed probe 3 (e.g., the probe 3 that is to be used for monitoring process-level resources). System 100 may store data specifying the current configuration of the probe 3 in a memory, such as memory 101 and/or another memory medium, for example.

In S406, system 100 may reconfigure the active and deployed probe 3 (e.g., the probe 3 that is to be used for monitoring process-level resources) to monitor one or more process-level resources. Such process-level resources may be associated with processes and/or resources that are themselves associated with the system-level resource that crossed the threshold in S310, for example.

In S408, which may occur after system 100 makes a negative determination (S402: NO) in S402, system 100 may activate a new and/or inactive probe 3 to monitor one or more process-level resources. Similar to S406, such process-level resources may be associated with processes and/or resources that are themselves associated with the system-level resource that crossed the threshold in S310, for example.

Referring now to FIG. 5, a process of un-deploying the second probe deployed in accordance with FIG. 4 now is described.

In S502, system 100 may determine whether one or more of the probes 3 deployed (e.g., newly deployed or reconfigured) to monitor a process-level resource was previously deployed to perform another function. A previously-deployed probe that was reconfigured in S406 after making a positive determination (S402: YES) in S402 and storing the probe's previous configuration in S404 may be an example of a probe 3 that was previously deployed to perform another function. A probe that was newly deployed or activated to monitor a process-level resource, however, may be an example of a probe 3 that was not previously deployed to perform another function. Accordingly, when system 100 determines that a probe 3 deployed to monitor a process-level resource was previously deployed to perform another function, the process may proceed to S504. Conversely, when system 100 determines that a probe 3 deployed to monitor a process-level resource was not previously deployed to perform another function, the process may proceed to S510.

In S504, system 100 may access the data specifying the previous configuration of the probe 3 stored in the memory in S404. Thereafter, in S506, system 100 may reconfigure the probe 3, which was deployed to monitor the process-level resource, to such probe's previous configuration based on the data accessed in S504. In certain implementations, such configuration may be the probe's configuration immediately before being reconfigured to monitor the process-level resource. In other implementations, such configuration may be a previous configuration of the probe 3 other than the probe's configuration immediately before being reconfigured to monitor the process-level resource, such as a previous configuration at a certain time in the past or a default configuration. For example, in the probe's previous configuration, the probe 3 may have been configured to monitor a different resource and/or a different resource level. In some configurations, in the probe's previous configuration, the probe 3 may have been configured to perform another function, such as a function other than monitoring. In S508, system 100 may control the reconfigured probe 3 to perform the probe's previous function, such as monitoring a different resource and/or a different resource level or performing some other non-monitoring function that the probe was previously configured to (and now reconfigured to) perform.

In S510, system 100 may deactivate the probe 3 deployed to monitor a process-level resource, so that such probe 3 may later be activated and deployed again to monitor the process-level resource, to monitor another process-level resource, to monitor a system-level resource, and/or to perform another function. In some implementations, system 100 may reconfigure or otherwise reallocate such probe 3 to monitor another process-level resource, to monitor a system-level resource, and/or to perform another function without deactivating the probe 3 in order to efficiently allocate the resources of system 100.

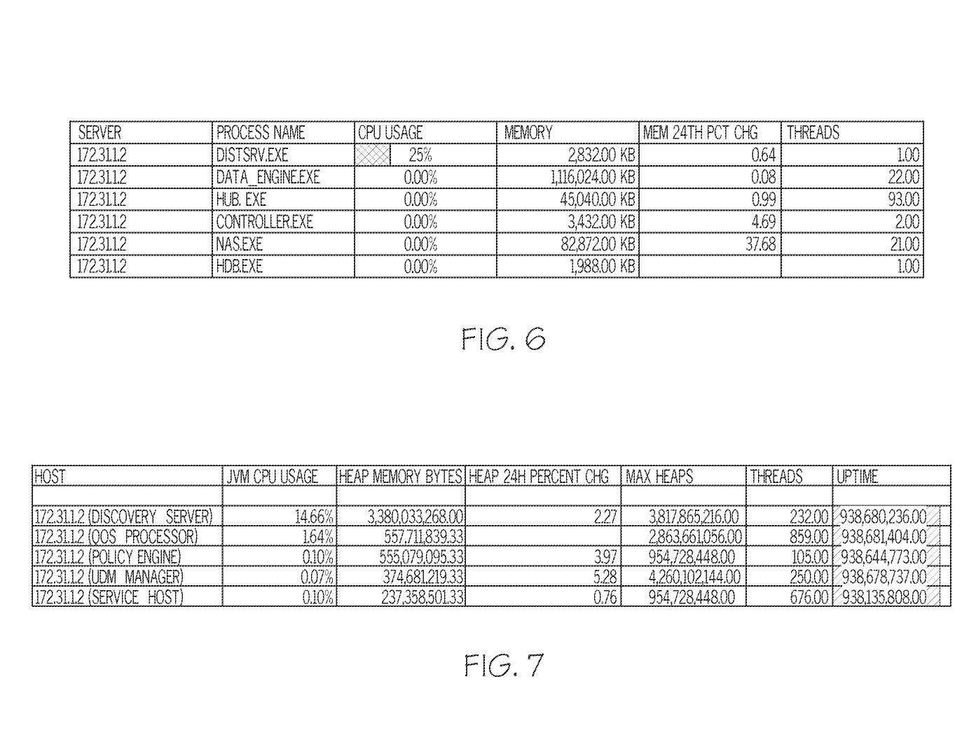

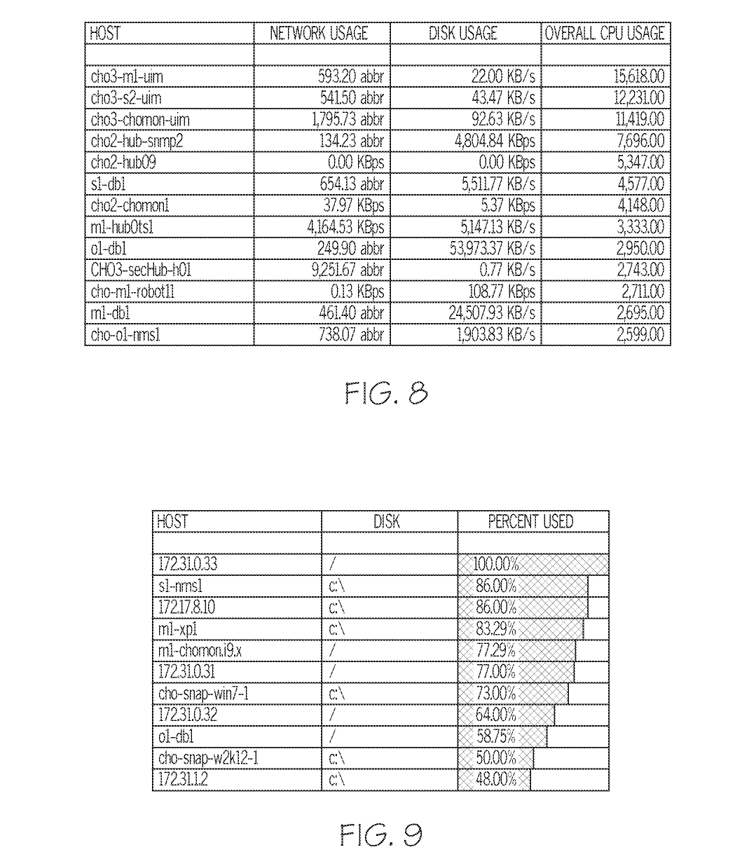

Particular implementations of a monitoring probe disclosed herein may use the UIM product API to access robots (including hubs), and even systems monitored using remote probes in some implementations, on a configurable interval (e.g., default 60 second intervals) to gather the such robots' and/or systems' metrics. The retrieved metrics may be published to a database, such as a Nimsoft/UIM database. A dashboard may be created in conjunction with such data aggregation, and the dashboard may present table views of process-level resources, such as the process-level resources identified in the tables shown in FIGS. 6 and 7, and table views of system-level resources, such as the system-level resources identified in the tables shown in FIGS. 8 and 9. For example, the processes represented by the table in FIG. 6 may be the “DISTSRV.EXE”, “DATA_ENGINE.EXE”, “HUB.EXE”, “CONTROLLER.EXE”, “NAS.EXE”, and HDB.EXE″ processes, which are running on the 172.31.1.2 server, for example. Similarly, the processes represented by the table in FIG. 7 may be the “DISCOVERY_SERVER”, “QOS_PROCESSOR”, “POLICY_ENGINE”, “UDM_MANAGER”, and “SERVICE_HOST” processes, which are running on the 172.31.1.2 server, for example. Likewise, metrics regarding a plurality of system-level resources, such as the “cho3-ml-uim”, “cho3-s2-uim”, “sl-dbl”, etc. hosts, are shown in the table in FIG. 8. FIG. 9 also shows another table identifying metrics related to a plurality of system level resources, such as the “172.31.0.33”, “sl-nmsl”, “cho-snap-win7-1”, etc. hosts. The data presented in the table views may be sortable by any of the collected metrics or even based on filter criteria, such as origin, and the tables and/or dashboard may provide an interface including the ability to drill-down for time-series views for particular resources, or for more-detailed information regarding particular messages, hubs, systems, probes, and other components. The dashboard may be part of a web-based user interface, for example.

A powerful aspect of systems and methods disclosed herein is that, by virtue of selectively collecting the information about process-level resources, the number of probes required (and the processing capability/resources required) used to monitor the UIM system and diagnose anomalies may be significantly reduced. Further, one or more probes may be used to perform different functions until otherwise needed to monitor process-level resources and dynamically repurposed. Consequently, the probes may be used to efficiently monitor ULM systems.

The flowcharts and diagrams in FIGS. 1-9 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method comprising:
deploying a first probe within a unified infrastructure management (UM) system to monitor a system-level resource;
determining that a monitored value for the system-level resource has crossed a threshold value;
in response to determining that the monitored value fir the system-level resource has crossed the threshold value, deploying a second probe within the UIM system to monitor a process-level resource; and
storing information about the process-level resource obtained by the second probe in a memory.

2. The method of claim 1, further comprising:
in response to determining that the monitored value for the system-level resource has crossed the threshold value, generating an alert indicating that the monitored value for the system-level resource has crossed the threshold value, the alert tagged with a link to the information about the process-level resource obtained by the second probe.

3. The method of claim 1, further comprising:
providing the information about the process-level resource obtained by the second probe in a user interface, the user interface presenting the information about the process-level resource graphically.

4. The method of claim 1, wherein deploying the second probe within the UIM system to monitor the process-level resources comprises:
determining whether the second probe is already deployed within the UIM system in a first configuration to monitor a particular resource; and
in response to determining that the second probe is already deployed within the UIM system in the first configuration:
storing information specifying the first configuration of the second probe in the memory;
reconfiguring the second probe in a second configuration to monitor the process-level resource; and
controlling the second probe in the second configuration to obtain the information about the process-level resource.

5. The method of claim 4, further comprising:
determining that the monitored value for the system-level resource has crossed the threshold value in an opposite direction; and
in response to determining that the monitored value for the system-level resource has crossed the threshold value in the opposite direction:
accessing the information specifying the first configuration of the second probe in the memory;
reconfiguring the second probe in the second configuration to monitor the particular resource; and
controlling the second probe in the first configuration to monitor the particular resource.

6. The method of claim 1,
wherein the system-level resource is total processor utilization for a particular device within the UIM system, and
wherein the process-level resource is a processor utilization for a particular process running on the particular device.

7. The method of claim 1,
wherein the system-level resource is a total memory utilization for a particular device within the UIM system, and
wherein the process-level resource is a memory utilization for a particular process running on the particular device.

8. The method of claim 1,
wherein deploying the second probe within the UIM system comprises:
activating the second probe; and
collecting information about a plurality of process-level resources including the information about the process-level resource,
wherein the method further comprises:
providing the information about the plurality of process-level resources in a user interface, the user interface providing access to the information about the plurality of process-level resources with central visualization.

9. The method of claim 8, further comprising:
providing an option in the user interface to select a particular one of the plurality of process-level resources; and
providing detailed information about the particular one of the plurality of process-level resources in response to receiving a selection of the particular one of the plurality of process-level resources.

10. The method of claim 1,
wherein the first probe is deployed from a particular hub, and
wherein the second probe is also deployed from the particular hub.

11. A system comprising:
a processing system configured to:
deploy a first probe within a unified infrastructure management (UIM) system to monitor a system-level resource;
determine that a monitored value for the system-level resource has crossed a threshold value;
in response to determining that the monitored value for the system-level resource has crossed the threshold value, deploy a second probe within the UIM system to monitor a process-level resource; and
store information about the process-level resource obtained by the second probe in a memory.

12. The system of claim 11, wherein the processing system is further configured to:
in response to determining that the monitored value for the system-level resource has crossed the threshold value, generate an alert indicating that the monitored value for the system-level resource has crossed the threshold value, the alert tagged with a link to the information about the process-level resource obtained by the second probe.

13. The system of claim 11, wherein the processing system is further configured to:
provide the information about the process-level resource obtained by the second probe in a user interface, the user interface presenting the information about the process-level resource graphically.

14. The system of claim 11, wherein, when deploying the second probe within the UIM system to monitor the process-level resources, the processing system is configured to:
determine whether the second probe is already deployed within the UIM system in a first configuration to monitor a particular resource; and
in response to determining that the second probe is already deployed within the UIM system in the first configuration:
store information specifying the first configuration of the second probe in the memory;
reconfigure the second probe in a second configuration to monitor the process-level resource; and
control the second probe in the second configuration to obtain the information about the process-level resource.

15. The system of claim 14, wherein the processing system is further configured to:
determine that the monitored value for the system-level resource has crossed the threshold value in an opposite direction; and
in response to determining that the monitored value fir the system-level resource has crossed the threshold value in the opposite direction:
access the information specifying the first configuration of the second probe in the memory;
reconfigure the second probe in the second configuration to monitor the particular resource; and
control the second probe in the first configuration to monitor the particular resource.

16. The system of claim 11,
wherein the system-level resource is total processor utilization for a particular device within the UIM system, and
wherein the process-level resource is a processor utilization for a particular process running on the particular device.

17. The system of claim 11,
wherein the system-level resource is a total memory utilization for a particular device within the UIM system, and
wherein the process-level resource is a memory utilization for a particular process running on the particular device.

18. The system of claim 11,
wherein, when deploying the second probe within the UIM system, the processing system is configured to:
activate the second probe; and
collect information about a plurality of process-level resources including the information about the process-level resource,
wherein the processing system is further configured to:
provide the information about the plurality of process-level resources in a user interface, the user interface providing access to the information about the plurality of process-level resources with central visualization.

19. The system of claim 18, wherein the processing system is further configured to:
provide an option in the user interface to select a particular one of the plurality of process-level resources; and
provide detailed information about the particular one of the plurality of process-level resources in response to receiving a selection of the particular one of the plurality of process-level resources.

20. A computer program product comprising:
a computer readable storage medium having computer readable program code embodied therewith, the computer readable program code comprising:
computer readable program code configured to deploy a first probe within a unified infrastructure management (UIM) system to monitor a system-level resource;
computer readable program code configured to determine that a monitored value for the system-level resource has crossed a threshold value;
computer readable program code configured to, in response to determining that the monitored value for the system-level resource has crossed the threshold value, deploy a second probe within the UIM system to monitor a process-level resource; and
computer readable program code configured to store information about the process-level resource obtained by the second probe in a memory.
